(19) United States
(12) Patent Application Publication
(10) Pub. No.: US 2022/0314249 A1
(43) Pub. Date: Oct. 6, 2022

(54) SYSTEM AND METHOD FOR CONTROLLING THE DISPENSING OF AN APPLICATION FLUID FROM A SPRAY SYSTEM

(71) Applicant: Droplet IP Holdings, LLC, Sanford, FL (US)

(72) Inventor: AC Lockyer, Winter Springs, FL (US)

(21) Appl. No.: 17/708,851

(22) Filed: Mar. 30, 2022

Related U.S. Application Data
(60) Provisional application No. 63/167,856, filed on Mar. 30, 2021.

(51) Int. Cl. B05B 7/12; B05B 7/26; B05B 12/02; B05B 12/14

(52) U.S. Cl. CPC B05B 7/12; B05B 7/267; B05B 12/02; B05B 12/1418

(57) ABSTRACT

A spraying system for applying an application fluid having an induction manifold, a hose reel subsystem, a pump element disposed between the manifold and the hose reel subsystem, an application fluid subsystem having a plurality of reservoirs and associated valves, a fluid regulating device coupled to an input end of the induction manifold for regulating the amount of a first fluid supplied thereto, a timer element coupled to the fluid regulating device for selectively activating the fluid regulating device via an activation signal, and a controller for controlling operation of the timer element. The controller generates a control signal in response to user instructions and in response to the control signal the timer element generates the activation signal. In response to the activation signal, the fluid regulating element ceases introduction of the first fluid into the manifold and introduces a second fluid therein.

### RELATED APPLICATION

The present application claims priority to U.S. provisional patent application Ser. No. 63/167,856, filed on Mar. 30, 2021, and entitled Push To Signal Chemical Change Notification System And Method, the contents of which are herein incorporated by reference.

### BACKGROUND OF THE INVENTION

The present invention is directed to spraying type systems for spraying a fluid for treating a surface.

Many different types of spraying systems exist for allowing an operator to spray a selected type of fluid onto a surface. Conventional spraying systems have evolved in the cleaning and agricultural world by allowing for “shift on the fly” metering or introduction of varying chemical or product mixes. This creates a spraying system that allows the operator flexibility in varying or altering chemical strengths, product mixes and formulas, or various products being sprayed or dispensed from a single application hose onto a surface to be cleaned.

The operator of the hose or wand that forms part of the conventional spray systems can typically smell or feel the particular solutions being dispensed by the wand in order to determine the specific chemical or cleaning solution being dispensed. As such, the operator can determine whether the correct solution is being dispensed based on the smell or feel of the chemicals being dispensed. A drawback of this approach is that the operator can be exposed to potentially harmful fumes from the chemicals or solutions being dispensed, which can potentially give rise to adverse health issues if the operator is exposed to the fumes or chemicals over a prolonged period of time.

Alternatively, conventional spraying systems can allow the operator to manually switch between solutions to be applied by selecting a specific discrete reservoir having a specific cleaning solution contained therein that is to be dispensed. It is common in the industry for the operator to wait for the change in solution to occur, or can designate a bolus of one of the solutions to be used as a sacrificial solution, so as to ensure that the selected solution is actually being dispensed. When the sacrificial solution is dispensed, the operator can quickly and easily determine that the correct solution will immediately follow thereafter. A drawback of this conventional approach is that it intentionally wastes solution that is being used as the sacrificial solution, which can be costly over time.

Additionally, in many cases, each solution tank requires a separate pumping system and hose reel. Injection/metering systems coupled to solution tank eliminate the need for separate pumps and reels, however since the solutions flow through a single reel, determining where and when the chemical change occurs is difficult. The savings in time and effort using an injection/metering system is lost due to the waste of excess chemicals and the exposure to chemicals and vapors during when the operator determines what product is being dispensed from the hose of the spray system.

### SUMMARY OF THE INVENTION

The present invention is directed to a spraying system that includes a controller and timer for controlling the activation of a fluid regulating device, such as a solenoid valve, that can be used to cease the introduction of a first fluid, such as water, into an induction manifold having a mixing chamber and instead introduce a second fluid, such as air or a colored liquid, therein. The second fluid can be used to purge the mixing chamber and associated fluid passages in the system and to induce a cavitation phenomenon in a pump element that is used to pump the fluids through the system. The cavitation phenomenon results in a fluid gap (e.g., air gap) within the dispensing or application hose of the spraying system that results in a sputtering at the tip of a wand element that is being used to apply an application fluid to a surface to be treated. The sputtering effect functions as an audible and tactile indication that the system has purged the prior application fluid mixture from the system. The timer element can be used to set a time period for introducing more or less air into the system producing a more or less significant sputtering if air is the second fluid or function as a visual indicator if the second fluid is a colored liquid.

The present invention is directed to a spraying system for treating a surface or a biological organism with an application fluid. The system can include an induction manifold having an input end and an output end; a hose reel subsystem; a pump element coupled at an input end to the output end of the induction manifold and at an opposed output end to the hose reel subsystem, an application fluid subsystem having a plurality of reservoirs, wherein the plurality of reservoirs are selectively fluidly coupled to the induction manifold; a fluid regulating device coupled to the input end of the induction manifold for regulating the amount of a first fluid supplied thereto; a timer element coupled to the fluid regulating device for selectively activating the fluid regulating device via an activation signal; and a controller for controlling operation of the timer element. The controller generates a control signal in response to user instructions that is conveyed to the timer element, and in response the timer element generates the activation signal. In response to the activation signal, the fluid regulating element ceases introduction of the first fluid into the induction manifold and introduces a second fluid into the induction manifold.

The system can further include a power source that is coupled at least to the controller and to the pump element. The first fluid can be water and the second fluid can be air or a colored liquid. Further, one or more of the reservoirs can house an application fluid. Each of the reservoirs of the application fluid subsystem can be fluidly coupled to the induction manifold by a respective valve element. The fluid regulating element can be a valve, such as a solenoid valve.

The hose reel subsystem can include a reel element, a hose element configured to be wound about the reel element, and a dispensing element fluidly coupled to the hose element.

The present invention is also directed to a method for treating a surface or a biological organism with a spraying system, comprising providing an induction manifold with an internal mixing chamber for mixing a first fluid with a first application fluid to form a first mixed application fluid; drawing the first mixed application fluid from the mixing chamber to a hose reel subassembly via a fluid passage so that the first mixed application fluid can be applied by a user; controlling the flow of the first fluid to the induction manifold with a fluid regulating element; upon actuation by the user, controlling the fluid regulating device to automatically cease the flow of the first fluid to the induction manifold for a selected period of time and automatically introducing a second fluid to the mixing chamber of the induction chamber during the selected period of time; automatically conveying the second fluid to the hose reel assembly via the fluid passage so as to purge the fluid passage of the first mixed application fluid; upon completion of the selected period of time, automatically controlling the fluid regulating device to automatically cease introduction of the second fluid to the mixing chamber and then reintroducing the first fluid to the mixing chamber; mixing the first fluid with a second application fluid in the mixing chamber to form a second mixed application fluid; and drawing the second mixed application fluid from the mixing chamber to the hose reel subassembly via the fluid passage.

The first fluid can be water and the second fluid can be air or a colored liquid. The method can also include providing power to the fluid regulating device. The method can also include providing an optional switch element for actuation by the user for controlling the fluid regulating device. An application fluid subsystem can also be provided and can include a plurality of reservoirs associated for housing the first and second application fluids. The application fluids can be selectively fluidly coupling each of the reservoirs with the mixing chamber. The hose reel subsystem can include a reel element, a hose element configured to be wound about the reel element, and a dispensing element fluidly coupled to the hose element. The fluid regulating element can be a valve, such as a solenoid valve.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a schematic block diagram of a spraying system according to the teachings of the present invention.

FIG. 2 is a schematic diagram illustrating the various components of the spraying system according to the teachings of the present invention.

FIG. 3 is a schematic flow chart diagram showing the operation of the spraying system of the present invention.

### DETAILED DESCRIPTION

The present invention is directed to a spraying system and associated method for dispensing various types of application fluids or combination or mixes of application fluids from a single applicator, such as a hose element or spray wand, of the spraying system. The spraying system can employ structure that allows the operator to generate a signal of any selected type that provides feedback (e.g., such as tactile, visual or auditory feedback) to the operator, by way of example via the applicator, to indicate that a different application fluid or combination of application fluids is about to or is being dispensed.

As used herein, the term “spraying system” or “spraying systems” is intended to include any type of spraying system that can be used to store, mix and spray or dispense one or more types of application fluids so as to treat a surface or a biological organism. Examples of spraying systems can include high volume type spraying systems, low volume type spraying systems, ultra-low volume type spraying systems, pesticide type spraying systems, soft wash type spraying systems, and the like.

As used herein, the term “application fluid” or “application fluids” is intended to include any type of fluid having a chemical mixture, solution, concentrate, solvent, solute, chemical substance, substance and the like, or combinations of the foregoing, that are mixed, suspended, or dissolved in the fluid and that can be applied or sprayed on a surface by an application element, such as a nozzle or spray wand, so as to treat a surface or a biological organism. Examples of suitable application fluids can include pesticides, insecticides, herbicides, fungicides, larvicides, mildewcides, algaecides, ovicides, plant growth inhibitors, miticides, disinfectants, defoliants, antimicrobials or microbicides, attractants, nematicides, rodenticides, cleaning solutions, and the like.

As used herein, the term “cleaning solution” or “cleaning fluid” is intended to include any conventional solvents, fluids, chemical agents, chemical substances, solvents, solutes, mixtures and solutions, concentrated or not, that can be used to clean or treat a surface. The cleaning solutions can include any combination of soaps, bleaches, degreasers, rust removers, mildewcides, fungicides, and like solutes, that can be mixed with or dissolved in a solvent, such as water. According to one practice, the cleaning solution an include biodegradable water-based chemicals.

As used herein, the term “treat” is intended to mean remove, dissolve, emulsify, destroy, control or repel a biological organism, such as algae, pests, fungus, mildew, and the like, or to clean, remove or dissolve contaminants, dirt, grime, mildew, fungus, algae, and the like from a surface.

The spraying system of the present invention can be used to treat any selected type of surface, such as plants, walls, floors, roofs, soil, and the like, or to treat one or more types of biological organisms. The spraying system, such as a soft wash spraying system, is typically employed when high-pressure washing is too powerful and can potentially damage the surface to be cleaned. As such, the soft wash spraying system can be configured to apply the proper amount or level of water pressure to clean the surface without damaging the surface.

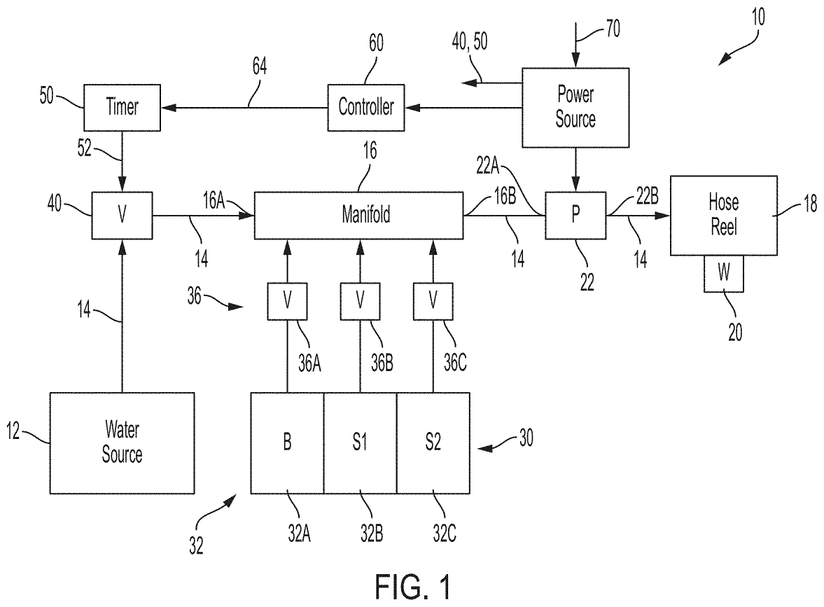

FIG. 1 is a general schematic block diagram illustrating a spraying system 10 according to the teachings of the present invention. The spraying system 10 can be any type of spraying system for applying any type of application fluid, but is described herein, for purposes of simplicity, as being a soft wash type spraying system for applying a cleaning fluid to a surface to be treated. The spraying system can also be configured for applying a pesticide to any selected types of surface or biological organism. The illustrated spraying system 10 can include a fluid source 12, such as for example a water source, for supplying a fluid or water to the system. The water can function as a carrier fluid or solvent for the cleaning solutions or solutes of the system. The water from the fluid source 12 can be conveyed to the remainder of the system through any selected type of fluid conduit subsystem. For example, the fluid source 12 can be coupled to the remainder of the system by any suitable type of fluid pipes or passages 14 that are arranged to fluidly couple together selected fluid delivering and receiving components of the system. Those of ordinary skill in the art will readily recognize that the fluid source 12 can provide any selected type of fluid to the system provided that the first fluid is compatible with the application fluid.

The illustrated spraying system 10 also includes an induction manifold 16 that is fluidly coupled at an input end 16A to the fluid source 12. The induction manifold 16 is also fluidly coupled at an output end 16B to a hose reel subsystem 18 via a pump element 22. The hose reel subsystem 18 can include a reel element and a hose element that is configured to be wound about the reel element. The hose element can terminate in a suitable fluid applicator or dispensing element 20, such as for example a nozzle or a wand. The hose element can be wound about the reel so as to store a suitable length of the hose element. The illustrated pump element 22 can be disposed between the induction manifold 16 and the hose reel subsystem 18 for pumping fluid through the fluid passages 14, inductions manifold 16, and hose reel subsystem 18 of the system 10. The pump element 22 has an inlet or input side 22A, also referred to as a vacuum side, that is fluidly coupled to the output end 16B of the induction manifold, and an outlet or output side 22B, also referred to as a pressure side that is fluidly coupled to the hose reel subsystem 18. Specifically, the input side 22A of the pump element 22 is coupled to the output end of the induction manifold 16 and the output side 16B of the pump is coupled to the hose reel subsystem 18.

An application fluid subsystem 30 can be coupled to the induction manifold 16 for delivering one or more application fluids to the induction manifold for mixing with the water flowing therethrough. According to the current example, in a soft wash system, the application fluid subsystem can be configured as a cleaning fluid subsystem that includes a series of reservoirs 32A-32C for housing various cleaning fluids. Those of ordinary skill in the art will readily recognize that any suitable number of reservoirs 32 can be included in the cleaning fluid subsystem 30 and that any suitable combination of cleaning fluids or solutions can be employed by the system of the present invention based on the type of surface to be treated and the specific types of contaminants to be removed from the surfaces. The type of cleaning fluids contained in the reservoirs 32A-32C can vary based on the type of treatment that needs to be performed, as is known in the art. The cleaning fluids can be mixed with a mixing fluid, such as water, supplied from the fluid source 12 and can be dispensed by the dispensing element or device 20 to treat the surfaces by, for example, emulsifying the contaminants (e.g., dirt and grime) and to remove and/or treat if necessary mildew, bacteria, mold, fungi, algae, viruses, and the like.

The reservoirs 32A-32C can be coupled to the induction manifold 16 via associated fluid regulating devices, such as metering valves 36. For example, the reservoir 32A can be coupled to the induction manifold 16 via the metering valve 36A, the reservoir 32B can be coupled to the induction manifold 16 via the metering valve 36B, and the reservoir 32C can be coupled to the induction manifold 16 via the metering valve 36C. The valves 36 can have selected indicia associated therewith to indicate an amount of cleaning solution that is to be introduced into the induction manifold 16. The valves 36 can be manually, digitally, or automatically set, adjusted or varied so that one or more of the cleaning fluids from the reservoirs 32A-32C is introduced into the induction manifold 16.

The induction manifold 16 has an output end 16B that is coupled to the input side 22A of the pump element 22 and has an input end 16A that is coupled to the fluid passage 14 that has associated therewith a controllable fluid regulating device 40. The fluid regulating device 40 can be any selected type of device that is suitable for regulating, adjusting, or varying the amount of fluid passing therethrough. Examples of suitable fluid regulating devices can include flow controllers, closable orifices or openings, two way valves, three way valves, solenoid valves, ball valves, butterfly valves, gate valves, globe valves, check valves, plug valves, hydraulic valves, needle valves, disc valves, pinch valves, diaphragm valves, and the like. According to one embodiment, the present application employs a fluid regulating device that is suitable for regulating the passage of the source fluid (e.g., water) therethrough while concomitantly introducing a second fluid, such as air or a colored liquid, into the fluid passages and the induction manifold 16. The induction manifold 16 functions as a fluid pass-through lumen and as a mixing or combining chamber where the cleaning fluids from the reservoirs 32A-32C are mixed or combined with a compatible fluid, such as water. The water stored in the fluid source 12 is controlled by the fluid regulating device 40 as the water passes through the fluid passage 14 and is drawn into the input end 16A of the induction manifold 16 by the pump element 22. One or more of the cleaning fluids held or stored in the reservoirs 32A-32C can be introduced into the induction manifold 16 via the metering valves 36A-36C so as to mix or combine the cleaning fluids with the mixing fluid to form a mixed cleaning fluid. The mixed cleaning fluid exits the induction manifold 16 at the output end 16B and is introduced to the pump element 22. The pump element 22 pumps or expels the mixed cleaning solution out of the output end 22B and introduces the solution to the hose reel subsystem 18. The applicator or dispensing element 20 (e.g., wand or nozzle) of the hose reel subsystem 18 applies or dispenses the mixed cleaning fluid onto the surface to be cleaned and treated.

The fluid regulating device 40 can also be coupled to a timer element 50 and to a power source 70, such as a battery. The power source 70 can also be coupled to the timer 50 and to the pump element 22 for providing power thereto. The illustrated soft wash spraying system 10 can also include a controller 60 having an activation element, such as a switch. The controller 60 is electrically coupled to the timer element 50, which in turn is coupled to the fluid regulating device 40, as well as to the power source, which supplied power thereto. The timer element 50 can be any suitable timer element that can be preset or programmed to count down a selected period or amount of time. Examples of suitable timer elements include analog timers, digital timers, mechanical timers, electrical timers, electromechanical timers, microcontrollers, digital signal controllers, and other types of timing elements such as those manufactured by Microchip Technology Inc. The timer element 50 can be programmed by the controller 60 or by the operator. The illustrated controller 60 can include an optional switch element that can be actuated by the operator, either manually or electronically, for generating an activation signal for receipt by the timer, or the controller can be configured to receive wireless or wired instructions from an operator via any suitable type of electronic device, such as a smart phone, computer, tablet computer, laptop computer, or the like, and can generate a control or activation signal that is conveyed to the timer element 50.

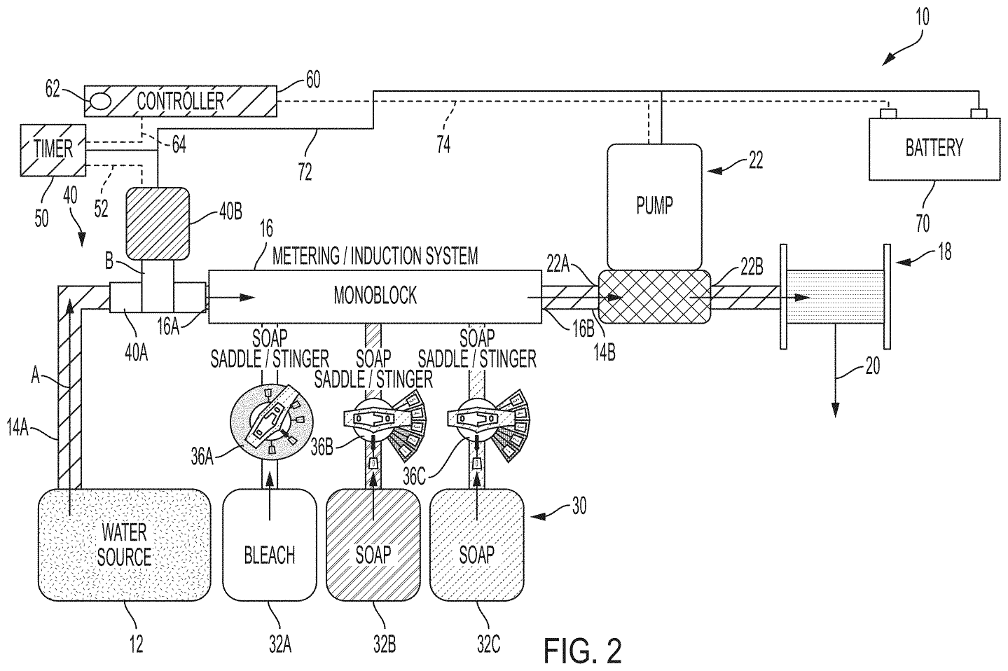

FIG. 2 is a schematic diagram illustrating one particular embodiment of the spraying system 10 of the present invention. Like reference numerals indicate like parts throughout the various views. The illustrated system 10 includes a fluid source 12, such as a water source, that is coupled to the induction manifold 16 via a fluid passage 14A. The fluid regulating device 40 is disposed between the fluid source 12 and an input end 16A of the induction chamber 16. The fluid regulating device 40 can be any selected type of valve element, and according to one embodiment, is a solenoid valve that includes a valve portion 40A that is coupled to a solenoid portion 40B. The solenoid portion 40B can be electrically coupled to the power source 70 by power line 72 for selectively actuating the solenoid portion 40B so as to open and close the valve portion 40A. The valve portion 40A of the solenoid valve 40 is coupled directly to the fluid passage 14A. The solenoid valve 40 is preferably a normally open valve that allows a second fluid, such as air or a colored liquid, to be introduced into the fluid passage 14A and hence the fluid passage system 14. The pump element 22 is disposed in a fluid passage 14B forming part of the overall fluid passage system 14 and is coupled at an input side 22A to the output 16B of the induction manifold 16 and at an output side 22B to the hose reel subsystem 18. The hose reel subsystem 18 can include a reel element and a hose element that can be wound about the reel element. The hose element can have coupled thereto at a terminal end a dispensing element, such as a wand, nozzle, and the like. The timer element 50 can be coupled to the valve element 40 and to the controller 60. The timer element 50 can also be coupled to the power line 72 and to the controller can be coupled to the power source 70 via power line 74. The controller 60 can include an optional switch element 62 that can be selectively actuated by the operator. Alternatively, the controller can be configured to receive wireless signals from an electronic device of the operator, such as a smart phone, computer or the like. The electronic device of the operator can include any suitable type of mobile application software that allows the operator to control the controller 60, which in turn can control the timer element 50.

The induction manifold 16 can also be coupled to the cleaning fluid subsystem 30 that includes any selected number of reservoirs for holding cleaning fluids. According to the current example, the cleaning fluid subsystem includes reservoirs 32A-32C. By simple way of example, the reservoir 32A can contain a bleach solution, reservoir 32B can hold a first type of soap solution, and the reservoir 32C can hold a second different type of soap solution. The reservoirs 32A-32C can be coupled to the induction manifold 16 by respective valve or metering elements 36A-36C, respectively. The metering valves can include dial like control interfaces that allow for the electronic or manual selection of selected amounts of the cleaning fluids to be introduced to the induction manifold 16.

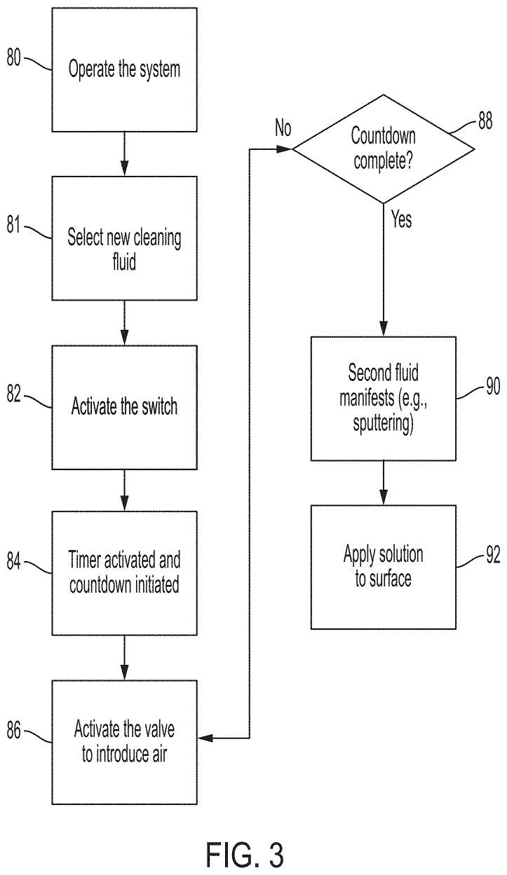

In operation, and with referenced to FIGS. 1-3, the operator can employ the spraying system 10 to treat a surface or biological organism, and according to the current example, can be used to clean contaminants from a selected surface with one or more cleaning fluids. During use, the water in the fluid source 12 is pulled by operation of the pump 22 through the fluid passage 14A and through the normally open valve element 40 and into the induction manifold 16. The operator can then select one or more cleaning fluids from the reservoirs 32A-32C to introduce into the induction manifold 16. The cleaning fluids, when added to the induction manifold 16, are mixed or combined with the water in the interior chamber thereof to form a mixed cleaning fluid or solution. The mixed cleaning solution is then pulled by the pump out of the output end 16B of the induction manifold 16, through the fluid passage 14B, and into the hose reel subsystem 18. The arrows A indicate the flow of the fluid through the system 10. The mixed cleaning solution can be pushed by the pump element 22 through any hose element that is coupled to the hose reel subsystem 18. The hose element can have an applicator or dispenser element 20, such as a nozzle or wand, coupled to a terminal end of the hose element so as to easily apply the mixed cleaning fluid to the surface to be treated or cleaned under a selected amount of pressure, step 80. The pump 22 and the valve element 40 are powered by the power source 70.

In conventional systems, when the operator wishes to change the type of application fluid (e.g., cleaning fluid) to add to the induction manifold 16, the operator simply adjusts, manually or electronically, one of the valve elements 36A-36C associated with the desired reservoir 32A-32C, thus introducing the cleaning fluid into the induction manifold 16, step 81. A drawback of this approach is that the newly added cleaning fluid is introduced to the interior chamber of the induction manifold 16 as well as to the fluid passage 14B, and the new cleaning fluid mixes with the prior mixed cleaning fluid already within the fluid passage. As such, there is a selected amount of sacrificial product that is pushed through the system prior to applying the proper mixed cleaning fluid to the designated surface. The operator can typically tell when the older combined solution fully passes through the system and the new cleaning solution combination is ultimately being dispensed based on the smell or feel of the solution exiting the dispenser element. This is unsafe and wastes cleaning fluid.

In the spraying system 10 of the present invention, rather than introduce the cleaning fluid housed within the reservoirs 32A-32C into the induction manifold 16 to be mixed with the prior solution, the operator can activate an optional switch element 62 that, according to one embodiment, can form part of the controller 60, step 82. Those of ordinary skill in the art will readily recognize that the switch element 62 can be implemented as a device that is separate from the controller 60. When the switch element 62 is activated, the controller 60 or the switch element can generate a control signal 64 that is conveyed to the timer element 50 in order to activate the timer element, step 84. Alternatively, the controller 60, when instructed by the operator, can generate a control signal 64 that is received by the timer element 50.

The timer element 50 can be preset or preconfigured to a selected period of time or the control signal 64 can set the timer element to a predetermined or user selected time period. The receipt of the control signal 64 by the timer element 50 starts or initiates the countdown. The timer element 50, once activated, generates an activation signal 52 that is received by the solenoid portion 40B of the valve element 40. The solenoid portion 40B, when activated by the activation signal 52, closes the normally open valve portion 40A and then introduces a selected amount or bolus of a second fluid, such as air, into the passage 14A and into the induction manifold 16, step 86. The air is then pulled or drawn by the pump element 22 through the fluid passage 14B and into the hose reel subsystem 18 and then through the hose element that is attached thereto. The valve portion 40A stays closed and hence prevents the introduction of water from the fluid source 12, while simultaneously introducing the air (arrow B) into the induction manifold 16 and the fluid passage 14B for the duration of the countdown period, step 88. The air travels through the induction manifold 16, into the fluid passage 14B and then into the pump element 22. The air introduced to the pump element 22 creates a cavitation effect, which serves to form an air gap between the first mixed cleaning solution within the passages and the next or new cleaning solution. The air then passes through the hose element and the cavitation manifests as sputtering at the applicator or dispenser end of the hose element, step 90. Hence, the spraying system 10 can provide an audible and tactile indication to the operator, in real time, that the fluid passages have been purged of the prior solution and that the system is primed for the introduction of a different cleaning solution into the induction manifold 16.

Once the countdown period of the timer element 50 is complete, the timer element 50 ceases generating the activation signal 52, which in turn powers down the solenoid portion 40B of the valve element 40. The deactivation of the solenoid portion 40B opens the valve portion 40A to once again allow for the introduction of water from the water source, through the valve portion 40A, and into the induction manifold 16, while concomitantly ceasing the introduction of air into the manifold. The controller 60, timer element 50 and the solenoid portion 40B are all coupled to the power source 70 for providing power thereto. The operator can then select a new cleaning solution from one of the reservoirs 32A-32C to introduce into the induction manifold 16, step 90. The operator can then apply the mixed cleaning solution to the surface to be treated or cleaned, step 92.

The introduction of air into the system 10 thus provides for an indicator or manifestation to the operator that the system is about to change or switch from one chemical type to another chemical type and that is going to be expelled from the hose element. The air gap created by the introduction of air into the induction manifold 16 forms a physical and auditory margin between the last chemical mixture being sprayed by the hose and the new or subsequent chemical mixture that is to be sprayed by the hose. This auditory signal is manifested as a sputtering of air at the applicator end of the hose, thus signaling that the new mixture is next after the air gap.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

Having described the invention, what is claimed as new and desired to be secured by Letters Patent is:

I claim:

1. A spraying system for treating a surface or a biological organism, comprising
an induction manifold having an input end and an output end,
a hose reel subsystem,
a pump element coupled at an input end to the output end of the induction manifold and at an opposed output end to the hose reel subsystem,
an application fluid subsystem having a plurality of reservoirs, wherein the plurality of reservoirs are selectively fluidly coupled to the induction manifold,
a fluid regulating device coupled to the input end of the induction manifold for regulating the amount of a first fluid supplied thereto,
a timer element coupled to the fluid regulating device for selectively activating the fluid regulating device via an activation signal, and
a controller for controlling operation of the timer element,
wherein the controller generates a control signal in response to user instructions that is conveyed to the timer element, and in response the timer element generates the activation signal, and
wherein in response to the activation signal, the fluid regulating element ceases introduction of the first fluid into the induction manifold and introduces a second fluid into the induction manifold.

2. The system of claim 1, further comprising a power source that is coupled at least to the controller and to the pump element.

3. The system of claim 1, wherein the first fluid is water and wherein the second fluid is air or a colored liquid.

4. The system of claim 3, wherein one or more of the plurality of reservoirs houses an application fluid.

5. The system of claim 4, wherein each of the plurality of reservoirs of the application fluid subsystem is fluidly coupled to the induction manifold by a respective valve element.

6. The system of claim 5, wherein the hose reel subsystem comprises a reel element, a hose element configured to be wound about the reel element, and a dispensing element fluidly coupled to the hose element.

7. The system of claim 6, further comprising a power source that is electrically coupled to the controller, to the pump element, to the fluid regulating element, and to the timer element.

8. The system of claim 7, wherein the fluid regulating element is a solenoid valve.

9. The system of claim 6, wherein the fluid regulating element is a valve element.

10. The system of claim 9, wherein the valve element is a three way valve element.

11. A method for treating a surface or a biological organism with a spraying system, comprising
providing an induction manifold with an internal mixing chamber for mixing a first fluid with a first application fluid to form a first mixed application fluid,
drawing the first mixed application fluid from the mixing chamber to a hose reel subassembly via a fluid passage so that the first mixed application fluid can be applied by a user,
controlling the flow of the first fluid to the induction manifold with a fluid regulating element,
upon actuation by the user, controlling the fluid regulating device to automatically cease the flow of the first fluid to the induction manifold for a selected period of time and automatically introducing a second fluid to the mixing chamber of the induction chamber during the selected period of time,
automatically conveying the second fluid to the hose reel assembly via the fluid passage so as to purge the fluid passage of the first mixed application fluid,
upon completion of the selected period of time, automatically controlling the fluid regulating device to automatically cease introduction of the second fluid to the mixing chamber and then reintroducing the first fluid to the mixing chamber,
mixing the first fluid with a second application fluid in the mixing chamber to form a second mixed application fluid, and
drawing the second mixed application fluid from the mixing chamber to the hose reel subassembly via the fluid passage.

12. The method of claim 11, wherein the first fluid is water and wherein the second fluid is air or a colored liquid.

13. The method of claim 12, further comprising providing power to the fluid regulating device.

14. The method of claim 12, further comprising providing a switch element for actuation by the user for controlling the fluid regulating device.

15. The method of claim 14, further comprising providing an application fluid subsystem having a plurality of reservoirs associated therewith for housing the first and second application fluids.

16. The method of claim 15, further comprising selectively fluidly coupling each of the plurality of reservoirs with the mixing chamber.

17. The method of claim 16, further comprising controlling the introduction of the first and second application fluids to the mixing chamber.

18. The method of claim 17, wherein the hose reel subsystem comprises a reel element, a hose element configured to be wound about the reel element, and a dispensing element fluidly coupled to the hose element.

19. The method of claim 17, wherein the fluid regulating element is a solenoid valve.

20. The method of claim 17, wherein the fluid regulating element is a valve element.
